(19) United States
(12) Patent Application Publication
(10) Pub. No.: US 2026/0204119 A1
(43) Pub. Date: Jul. 16, 2026

(54) Multi-Modal Physical Object Analysis System with Portable Testing Apparatus and Coordinated Software Processing

(71) Applicant: Vincent Cheng, Burnaby (CA)

(72) Inventor: Vincent Cheng, Burnaby (CA)

(21) Appl. No.: 19/449,537

(22) Filed: Jan. 15, 2026

Related U.S. Application Data
(60) Provisional application No. 63/746,047, filed on Jan. 16, 2025.

(51) Int. Cl. G07D 5/08; G07D 5/02; G07D 5/04

(52) U.S. Cl. CPC G07D 5/08; G07D 5/02; G07D 5/04; G07D 2205/00

(57) ABSTRACT

A system includes a portable physical testing apparatus and a computing device executing a software application. The portable physical testing apparatus includes a mass measurement module, a magnetic interaction module, and a dimensional interaction module, each configured to interact with an object and generate corresponding data. The magnetic interaction module includes a first magnetic element arranged to detect ferromagnetic interaction with the object and a second magnetic element arranged to move relative to the object in response to electromagnetic interaction with the object. The computing device captures acoustic data associated with the object and is communicatively coupled to the portable physical testing apparatus to receive mass data and magnetic response data. The software application processes the mass data, magnetic response data, dimensional data, and acoustic data in association with a reference dataset stored in memory.

### CROSS-REFERENCE TO RELATED APPLICATIONS

This application claims the benefit of U.S. Provisional Patent Application No. U.S. 63/746,047, filed 16 Jan. 2025, the entirety of which is incorporated herein by reference.

### FIELD OF INVENTION.

The present invention relates to systems for physical object analysis. More particularly, the disclosure relates to portable multi-modal testing systems combining physical interaction modules with coordinated software processing.

### BACKGROUND

The market for physical precious-metal coins and bars has expanded substantially in recent years, driven in part by increased retail participation, rising commodity prices, and declining trust in purely digital or paper financial instruments. A growing proportion of purchasers are first-time buyers who lack experience handling or verifying physical bullion and who rely heavily on secondary markets, online marketplaces, and peer-to-peer transactions. These environments present increased exposure to counterfeit products, particularly as modern manufacturing techniques have made it easier to produce visually convincing replicas that are difficult to distinguish through casual inspection alone.

Existing consumer-level authentication practices are fragmented and inconsistent. Buyers often rely on a single informal test, such as visual inspection, weight comparison, or a basic acoustic “ping” test, each of which is individually unreliable when used in isolation. High-quality counterfeits can be engineered to pass one or more of these individual checks, for example by matching weight using plated or alloyed cores, or by closely replicating external dimensions and surface features. As a result, users who rely on only one or two verification techniques remain exposed to false confidence and financial loss.

Professional analytical equipment such as X-ray fluorescence (XRF) scanners, ultrasonic testers, or laboratory-grade conductivity instruments can provide more reliable results, but these systems are expensive, bulky, and impractical for typical retail buyers. Their cost and operational complexity place them outside the reach of most consumers and small dealers, leaving a substantial gap between informal consumer methods and professional industrial testing. This gap is particularly problematic in decentralized trading contexts where rapid, on-site verification is desired but access to laboratory infrastructure is unavailable.

Software-based authentication tools, including mobile applications that analyze acoustic signals or compare images against reference databases, have been introduced to improve accessibility. However, such tools remain limited by the quality of user input, environmental noise, device variability, and the inherent constraints of software-only analysis. Acoustic methods, for example, are sensitive to background sound, striking technique, device microphone quality, and surface contact conditions, and visual methods can be defeated by high-fidelity replicas. Moreover, purely digital approaches are susceptible to being replicated, spoofed, or circumvented, and they lack direct physical interaction with the tested object's intrinsic material properties.

One of the closest references addressing physical authentication of precious metals is U.S. Pat. No. 10,497,198, which discloses a method for discriminating gold and silver coins and bars by performing a limited set of physical measurements, including weight, dimensional size, and conductivity-related behavior using a magnetic slide arrangement. The disclosed approach is directed toward identifying materials based on theoretical relationships between density and electrical conductivity, and it proposes a defined testing sequence to classify objects accordingly. However, this disclosure does not address acoustic signature analysis, does not integrate testing with consumer mobile devices, does not provide an apparatus combining multiple physical tests into a unified consumer-portable form, and does not address the challenges associated with user-level deployment, environmental variability, or coordinated interpretation of multiple heterogeneous test results.

Accordingly, there remains a need for improved approaches that address the shortcomings of both informal consumer methods and professional laboratory systems, particularly in the context of retail and peer-to-peer transactions. The increasing sophistication of counterfeit manufacturing, the limitations of single-mode verification, the impracticality of industrial equipment for everyday use, and the vulnerability of software-only solutions collectively highlight unresolved problems in the field. These conditions have driven efforts to develop more reliable, accessible, and resilient mechanisms for verifying the authenticity of physical precious-metal items in consumer environments.

It is within this context that the present invention is provided.

### SUMMARY

The present disclosure relates to a system for physical object analysis comprising a portable physical testing apparatus communicatively coupled to a computing device executing a software application. The portable physical testing apparatus includes a mass measurement module, a magnetic interaction module, and a dimensional interaction module, each configured to interact with an object and generate corresponding data. The computing device further captures acoustic data associated with the object, and the software application processes the mass data, magnetic response data, dimensional data, and acoustic data in association with a reference dataset stored in memory.

By integrating multiple heterogeneous physical measurement modalities with coordinated software processing, the disclosed system provides a unified platform for acquiring and correlating diverse object characteristics using a portable consumer-accessible architecture. The combination of physical interaction modules and mobile computing allows coordinated data capture, processing, and comparison while maintaining modularity, extensibility, and compatibility with a wide range of objects and reference datasets.

In some embodiments, the mass measurement module comprises a load cell, an analog-to-digital converter, and a controller, enabling high-resolution mass data generation with compact hardware architecture and low power consumption.

In further embodiments, the portable physical testing apparatus includes a wireless communication interface, such as a Bluetooth interface, allowing seamless data transfer to the computing device without physical connectors and improving portability and ease of use.

In yet further embodiments, the magnetic interaction module includes a guide structure that constrains movement of a magnetic element along a predetermined path, improving consistency and repeatability of magnetic response measurements.

In some embodiments, the guide structure is vertically oriented, enabling gravity-assisted movement of the magnetic element and reducing mechanical complexity.

In further embodiments, the magnetic interaction module includes one or more sensors configured to generate motion data associated with movement of the magnetic element, enabling quantitative characterization of magnetic interaction behavior.

In yet further embodiments, the sensors comprise optical sensors, Hall-effect sensors, or inertial sensors, providing flexible implementation options across cost, accuracy, and environmental robustness constraints.

In some embodiments, the dimensional interaction module comprises a sizing plate having a plurality of apertures or grooves corresponding to predetermined object diameters, enabling rapid visual or mechanical comparison without powered electronics.

In further embodiments, the sizing plate includes a thickness gauge comprising a wedge, ramp, or stepped surface, allowing thickness measurement using a compact, passive structure.

In yet further embodiments, the dimensional interaction module is physically separate from the mass measurement module and the magnetic interaction module, allowing modular use and independent replacement or upgrade.

In some embodiments, the dimensional interaction module is integrated into a housing of the portable physical testing apparatus, reducing the number of separate components and simplifying handling.

In further embodiments, the computing device includes at least one camera configured to capture image data associated with the object, enabling visual feature extraction and pattern comparison.

In yet further embodiments, the computing device includes a first camera arranged to capture a first side of the object and a second camera arranged to capture a second side of the object, enabling bilateral or multi-angle analysis.

In some embodiments, the software application generates frequency-domain data from the acoustic data, enabling identification of characteristic spectral features.

In further embodiments, the software application identifies a plurality of spectral peaks in the frequency-domain data, improving discrimination accuracy and robustness.

In yet further embodiments, the reference dataset includes dimensional reference data, acoustic reference data, magnetic reference data, image reference data, or combinations thereof, enabling multi-modal comparison.

In some embodiments, the reference dataset is stored locally on the computing device, enabling operation without network connectivity.

In further embodiments, the portable physical testing apparatus includes a housing configured to position the object at a predetermined location relative to the mass measurement module and the magnetic interaction module, improving measurement repeatability and reducing user-induced variability.

### BRIEF DESCRIPTION OF THE DRAWINGS

Various embodiments of the invention are disclosed in the following detailed description and accompanying drawings.

FIG. 1 illustrates an example of a portable physical testing apparatus comprising a sizing base plate positioned on a digital scale with a central step nub.

FIG. 2 illustrates an example of a magnetic interaction module comprising stacked magnetic elements separated by a spacer.

FIG. 3 illustrates an example of a sizing base plate having diameter comparison grooves and thickness comparison slots.

FIG. 4 illustrates an example of a test object positioned within a thickness comparison slot of the sizing base plate.

FIG. 5 illustrates an example of a test object positioned on a step nub supported by a sizing base plate on a digital scale.

FIG. 6 illustrates an example of a portable physical testing apparatus operatively associated with a computing device executing a software application.

FIG. 7 illustrates an example of an assembled configuration of the sizing base plate, step nub, and digital scale.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The term “portable physical testing apparatus” refers to any physical assembly, housing, or device configured to be transported and positioned by a user and to physically interact with an object in order to generate one or more types of measurement data. This includes, but is not limited to, tabletop devices, handheld devices, modular component assemblies, and enclosures integrated into consumer electronics accessories. In one example implementation, the portable physical testing apparatus may comprise a plastic or aluminum housing enclosing a load cell, one or more permanent magnets, and a microcontroller, powered by a rechargeable lithium-ion battery and configured to communicate wirelessly with a smartphone.

The term “mass measurement module” refers to any component or combination of components configured to generate data corresponding to the mass or weight of an object. This includes, but is not limited to, strain gauge load cells, piezoelectric sensors, electromagnetic force compensation balances, or other force-sensitive elements. In one example implementation, the mass measurement module may comprise a single-point aluminum load cell bonded with strain gauges, coupled to a Wheatstone bridge circuit, an analog-to-digital converter, and a microcontroller that converts sensed strain into a digital mass value.

The term “magnetic interaction module” refers to any component or assembly configured to generate data based on a magnetic field interaction with an object. This includes, but is not limited to, permanent magnets, electromagnets, magnetic field sensors, and mechanical structures configured to constrain or guide magnet movement relative to the object. In one example implementation, the magnetic interaction module may include a neodymium iron boron permanent magnet positioned adjacent a test surface to detect attraction, and a second neodymium or ferrite magnet guided along a vertical polymer or metal rail to allow controlled movement influenced by electromagnetic interaction with the object.

The term “dimensional interaction module” refers to any physical component configured to interact geometrically with an object to generate data relating to one or more physical dimensions of the object. This includes, but is not limited to, templates, plates, grooves, apertures, calipers, wedges, stepped gauges, or optical measurement elements. In one example implementation, the dimensional interaction module may comprise a stainless steel or molded polymer plate having laser-cut circular apertures of predetermined diameters and a tapered wedge region for thickness comparison.

The term “reference dataset” refers to any collection of stored data used by the software application to process, compare, or contextualize data generated by the system. This includes, but is not limited to, tables, databases, lookup files, trained model parameters, or combinations thereof stored locally or remotely. In one example implementation, the reference dataset may comprise a locally stored file containing acoustic frequency peak values, dimensional specifications, and magnetic response profiles for a set of known reference objects, encoded in a structured data format such as JSON, XML, or a relational database table.

Unless expressly stated otherwise, words such as “a,” “an,” and “the” are intended to include both singular and plural forms, and the term “about” is intended to accommodate ±10 % variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DESCRIPTION OF DRAWINGS

The following detailed description sets forth illustrative embodiments of a system for physical object analysis that integrates multiple physical interaction modalities with coordinated software processing. The disclosed system is directed to addressing limitations observed in existing approaches that rely on single-mode testing, isolated instruments, or software-only analysis, each of which is susceptible to inaccuracies, incomplete characterization, or susceptibility to circumvention when used independently.

As discussed in the Background, conventional techniques for evaluating physical objects frequently depend on a limited subset of measurable characteristics, such as mass alone, dimensional conformity alone, or acoustic response alone. These approaches are further constrained by fragmentation across multiple tools, lack of coordination between measurements, environmental sensitivity, and limited accessibility of professional-grade analytical equipment. Software-based approaches, while convenient, are constrained by the absence of direct physical interaction with the tested object and by variability in user input and operating conditions.

The disclosed embodiments address these limitations by combining multiple heterogeneous physical interaction modules within a portable apparatus and coordinating the resulting data with a computing device executing a software application. This architecture allows multiple independent physical characteristics of an object to be observed and processed within a unified system, while maintaining modularity, portability, and compatibility with consumer computing devices. The coordination between physical measurement modules and software processing further allows aggregation, correlation, and interpretation of disparate data types that are not readily comparable in conventional systems.

The embodiments described below illustrate representative configurations of the physical testing apparatus, the computing device, and their interaction, including example arrangements of mass measurement, magnetic interaction, dimensional interaction, acoustic capture, data communication, and reference data processing. These embodiments are provided to demonstrate the structure and operation of the system in a clear and enabling manner and are not intended to limit the scope of the claims.

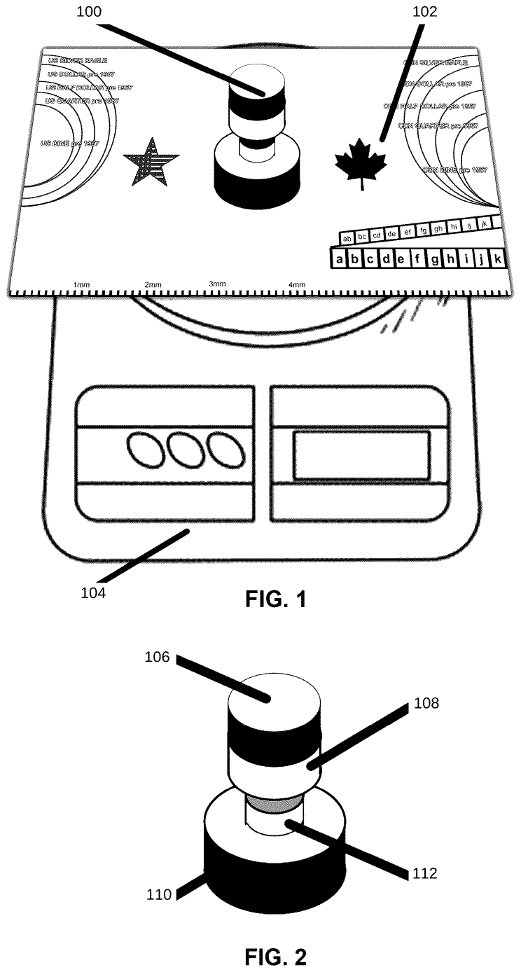

FIG. 1 illustrates a portable physical testing apparatus comprising a sizing base plate 102 supported on a digital scale 104 and carrying a step nub 100. The sizing base plate 102 is shown as a generally planar member providing multiple dimensional interaction features, including diameter comparison grooves, thickness comparison structures, and a linear scale, and may be formed from a rigid polymer, metal, composite laminate, or other dimensionally stable material. In some embodiments the sizing base plate 102 is injection-molded plastic with laser-cut or machined features, while in other embodiments it is stamped or milled metal or ceramic. The step nub 100 is mounted to the sizing base plate 102 and provides a raised physical interface for receiving a test coin or other object. The step nub 100 is shown as cylindrical and stepped, but may alternatively be conical, polygonal, or multi-tiered and may be coated with an elastomer, polymer sleeve, or non-marring surface to protect the object under test. The digital scale 104 comprises a load cell and associated electronics configured to generate mass data corresponding to objects supported thereon, and may further include internal signal processing, analog-to-digital conversion, local display elements, and wireless communication circuitry.

FIG. 2 illustrates an enlarged view of the magnetic interaction module mounted on the sizing base plate 102, comprising a top surface 106, a top magnet 108, a slider magnet 110, and a spacer 112. The top magnet 108 is positioned adjacent the top surface 106 and is configured to interact magnetically with a test object when the object is placed on the step nub 100 or directly on the top surface 106. The slider magnet 110 is arranged to move relative to the object and relative to the top magnet 108, and may be guided by a vertical or inclined guide structure not shown. The spacer 112 maintains a defined axial separation between the magnets and may be formed of a non-magnetic material such as plastic, aluminum, brass, or ceramic. The magnets may be neodymium iron boron, ferrite, samarium cobalt, or electromagnets, and the spacer thickness may be selected to control magnetic field strength, gradient, or interaction profile. In some embodiments sensors are associated with the slider magnet 110 to detect its position, velocity, or acceleration, although such sensors are not illustrated.

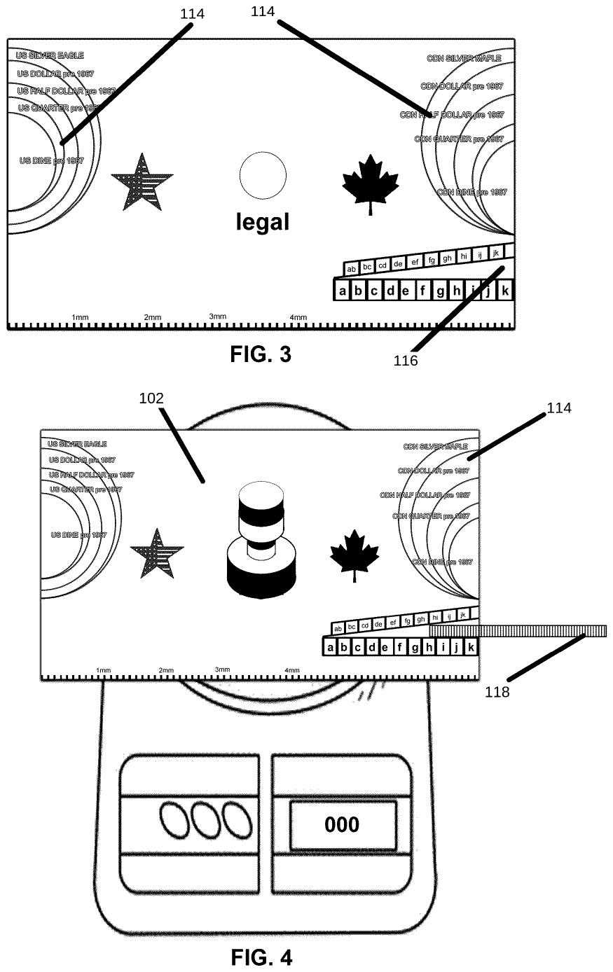

FIG. 3 illustrates the sizing base plate 102 in isolation, showing diameter grooves 114 and thickness slots 116. The diameter grooves 114 are configured to receive an object and constrain its lateral movement so that its diameter may be compared against a reference geometry, while the thickness slots 116 are configured to receive an edge of the object so that its thickness may be compared against a stepped or tapered profile. The grooves and slots may be machined, molded, laser-cut, or otherwise formed, and may be calibrated to correspond to predetermined dimensional standards. The sizing base plate 102 may further include printed, engraved, or embossed indicia, scales, or reference markings.

FIG. 4 illustrates the system in use with a test coin 118 inserted into one of the thickness slots 116 of the sizing base plate 102 while the sizing base plate 102 is supported on the digital scale 104. This configuration allows dimensional interaction and mass measurement to be performed in proximity or in combination. The test coin 118 is representative of any physical object and is not limited to coins or bullion.

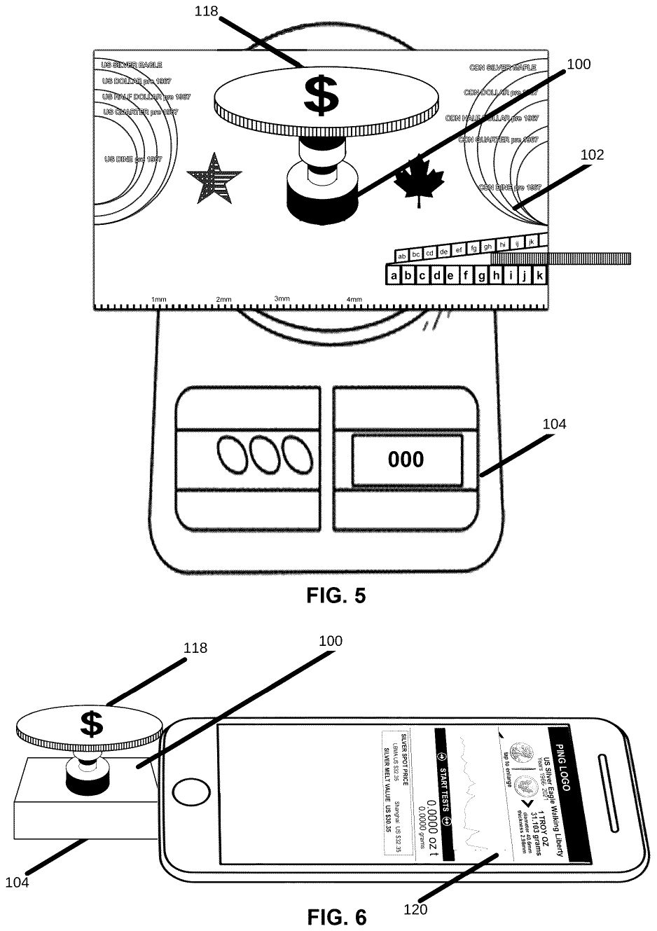

FIG. 5 illustrates the test coin 118 positioned on the step nub 100 on the sizing base plate 102, with the sizing base plate 102 supported by the digital scale 104. This configuration illustrates the positional relationship between the object, the magnetic interaction module, and the mass measurement module. The step nub 100 positions the test coin 118 at a defined elevation relative to the magnets and may also provide a consistent striking or excitation surface for acoustic testing.

FIG. 6 illustrates the system in operative association with a computing device executing a phone application 120. The test coin 118 is positioned on the step nub 100 supported by the digital scale 104, while the phone application 120 captures and displays data associated with the test. The phone application 120 may receive mass data and magnetic response data wirelessly from the digital scale 104 and associated electronics, and may capture acoustic data using an internal microphone or an external microphone associated with the physical apparatus. The phone application 120 may process mass, magnetic, dimensional, and acoustic data in association with a reference dataset and may further capture image data via one or more cameras.

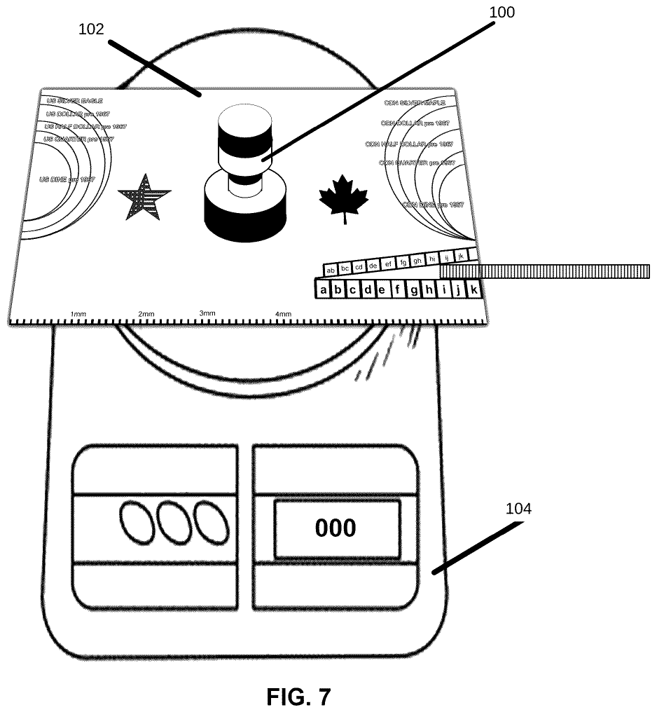

FIG. 7 illustrates a further assembled view of the system showing the sizing base plate 102 supported on the digital scale 104 with the step nub 100 mounted centrally thereon, illustrating the stacked integration of the dimensional interaction module, magnetic interaction module, and mass measurement module.

The system may be implemented such that the digital scale 104 includes a load cell, analog-to-digital conversion circuitry, a microcontroller, and a wireless interface. The phone application 120 may execute signal processing algorithms including FFT, peak detection, filtering, and normalization. The sizing base plate 102 may be detachable, replaceable, or integrated into a housing, and the step nub 100 and magnetic components may be modular or adjustable. The system may further incorporate cameras, additional sensors, or alternative excitation mechanisms. The architecture is modular and extensible, and components may be replaced or supplemented without altering the overall system configuration.

In further embodiments, the portable physical testing apparatus may be provided as a unitary assembly in which the sizing base plate 102 is integrated into a housing of the digital scale 104, or as a modular assembly in which the sizing base plate 102 is removably couplable to the digital scale 104 by mechanical fasteners, magnets, snap-fit features, adhesive, or an interference fit. Where removable, multiple sizing base plates 102 may be provided having different diameter grooves 114 and thickness slots 116 corresponding to different sets of reference objects. In some examples, the sizing base plate 102 is provided as a standalone accessory, as an attachment to a protective phone case, or as a compact promotional form factor such as a key chain, while maintaining functional dimensional interaction features.

In some embodiments, the step nub 100 may be configured to provide repeatable placement of the test coin 118 relative to the magnetic interaction module, and may be implemented as a multi-height pedestal, a recessed seat, a flange, a collar, or a compliant pad. The surface of the step nub 100 may be formed of a low-durometer elastomer, a polymer coating, a non-marring insert, or a replaceable cap, to reduce surface damage and to reduce acoustic damping variability in cases where the test coin 118 is excited while supported. In further embodiments, the step nub 100 includes a recess sized to receive a portion of the test coin 118 to reduce lateral movement during testing.

In some embodiments, the magnetic interaction module may employ different magnet geometries than those illustrated, including disc magnets, ring magnets, bar magnets, segmented magnet arrays, or Halbach arrays. The top magnet 108 and slider magnet 110 may be permanent magnets or electromagnets, and may be provided with pole-piece structures, magnetic flux concentrators, or shielding elements to shape the magnetic field. The spacer 112 may be fixed or adjustable, for example via threaded engagement, shims, or interchangeable spacer cartridges, to tune separation distance between the top magnet 108 and slider magnet 110 and thereby tune magnetic field characteristics for different object sizes or compositions.

In embodiments including controlled movement of the slider magnet 110, the slider magnet 110 may be constrained by a guide structure configured to define a repeatable movement path, which may be vertical, inclined, or curved. The guide structure may be implemented as a bore, rail, track, sleeve, or slot, and may include low-friction liners, bushings, bearings, or surface treatments. Although not shown, one or more sensors may be associated with the slider magnet 110 to generate motion data, including one or more optical sensors, Hall-effect sensors, inertial sensors, proximity sensors, or time-of-flight sensors, thereby enabling the phone application 120 to process magnet movement characteristics as a time-series. In further embodiments, the magnetic interaction module includes a release mechanism to initiate movement of the slider magnet 110 from a consistent starting position, such as a latch, detent, spring-biased catch, or electromagnetic hold.

In further embodiments, the dimensional interaction module may include diameter grooves 114 implemented as arcuate grooves, partial apertures, full apertures, nested cutouts, or stepped recesses. The thickness slots 116 may be implemented as discrete slots, stepped slots, or a continuous wedge region, and may include calibrated markings or detents. The sizing base plate 102 may include wear-resistant inserts at contact regions, such as hardened metal edges, ceramic inserts, or replaceable polymer liners, to maintain calibration over repeated use. Where dimensional data is captured electronically, the dimensional interaction module may include optical fiducials, machine-readable patterns, or known geometric landmarks on the sizing base plate 102 that are detectable by a camera and usable to infer object dimensions from images without requiring direct contact measurement.

In some embodiments, the digital scale 104 includes local processing and storage sufficient to perform tare functions, drift compensation, temperature compensation, filtering, and stability detection. The digital scale 104 may include a controller configured to packetize mass data for transmission to the computing device and to apply calibration coefficients stored in non-volatile memory. Power may be provided by replaceable batteries, rechargeable batteries, inductive charging, or external power, and in some embodiments the digital scale 104 includes a sleep mode and a wake mechanism responsive to user input or load detection.

The communicative coupling between the computing device and the portable physical testing apparatus may be implemented by a wired interface or a wireless interface. Example wireless interfaces include Bluetooth, Bluetooth Low Energy, Wi-Fi, NFC, and proprietary low-power radio links. Example wired interfaces include USB, USB-C, and audio-jack-based signaling. In some embodiments, the sizing base plate 102 or the digital scale 104 includes a machine-readable identifier, such as a QR code, NFC tag, or barcode, enabling the phone application 120 to identify the accessory type and load the associated reference dataset or calibration profile.

In some embodiments, acoustic data is captured using a microphone of the computing device, while in other embodiments acoustic data is captured using an external microphone integrated into the portable physical testing apparatus and transmitted to the computing device. Where an external microphone is used, the microphone may be positioned to reduce coupling to ambient noise, and may be provided with a windscreen, vibration isolation, directional pickup characteristics, or a contact pickup structure. The phone application 120 may apply time-windowing to isolate the acoustic transient, band-pass filtering to isolate expected resonant frequency bands, and normalization to reduce variability across devices. In further embodiments, the phone application 120 generates frequency-domain data via FFT and identifies multiple peaks, and may further compute peak ratios, harmonic spacing, spectral centroid, or other derived features, while retaining the reference dataset-driven comparison architecture described herein.

In some embodiments, the reference dataset comprises one or more of dimensional reference data, acoustic reference data, magnetic reference data, and image reference data, and may be organized as a relational database, flat file, or object store. The reference dataset may be stored locally on the computing device for offline use, stored remotely on a server, or partitioned between local and remote storage. Where remotely stored, updates may be delivered periodically and may include additional reference objects, revised data, or counterfeit exemplars. In further embodiments, the reference dataset includes multiple profiles per object type to accommodate manufacturing tolerances, wear, and known variants.

In embodiments including imaging, the computing device may capture one or more images of the test coin 118 and compare extracted features to reference images or feature descriptors stored in the reference dataset. Feature extraction may include edge detection, contour matching, keypoint detection, or template matching. In further embodiments, the computing device includes multiple cameras arranged to capture different sides of the object, or captures multiple views sequentially, and the phone application 120 associates the resulting image data with the mass data, magnetic response data, dimensional data, and acoustic data as part of a coordinated evaluation record.

While particular embodiments are described with reference to coins and bullion, the disclosed architectures are not limited to such objects, and may be applied to other physical objects for which mass, dimension, magnetic interaction, acoustic response, and/or image data provide useful distinguishing characteristics. Likewise, while example embodiments include passive magnetic elements, the magnetic interaction module may incorporate active excitation using an electromagnet driven by a controller, and the resulting response may be sensed using a magnetic field sensor or other sensor, without departing from the principles described herein.

Any processes described herein may be performed in a different order, in parallel, or with steps omitted or added, provided the claimed elements are present as recited. The various modules and components described may be distributed across the portable physical testing apparatus and the computing device in different ways, including embodiments in which processing is performed primarily on the computing device, primarily on the portable physical testing apparatus, or cooperatively across both. Accordingly, the described examples are intended to be illustrative rather than limiting, and variations, modifications, and equivalents will be apparent to those skilled in the art in view of the present disclosure.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
a portable physical testing apparatus; and
a computing device executing a software application;
wherein the portable physical testing apparatus comprises:
a mass measurement module configured to generate mass data associated with an object placed thereon;
a magnetic interaction module configured to generate magnetic response data associated with the object; and
a dimensional interaction module configured to generate dimensional data associated with the object;
wherein the magnetic interaction module comprises a first magnetic element arranged to detect ferromagnetic interaction with the object and a second magnetic element arranged to move relative to the object in response to electromagnetic interaction with the object;
wherein the computing device comprises a microphone configured to capture an acoustic response of the object and generate acoustic data associated with the object;
wherein the computing device is communicatively coupled to the portable physical testing apparatus to receive at least the mass data and the magnetic response data; and
wherein the software application is configured to process the mass data, the magnetic response data, the dimensional data, and the acoustic data in association with a reference dataset stored in a memory.

2. The system of claim 1, wherein the mass measurement module comprises a load cell, an analog-to-digital converter, and a controller configured to generate the mass data.

3. The system of claim 1, wherein the portable physical testing apparatus further comprises a wireless communication interface configured to transmit the mass data and the magnetic response data to the computing device.

4. The system of claim 3, wherein the wireless communication interface comprises a Bluetooth interface.

5. The system of claim 1, wherein the magnetic interaction module comprises a guide structure configured to constrain movement of the second magnetic element along a predetermined path relative to the object.

6. The system of claim 5, wherein the guide structure is oriented vertically.

7. The system of claim 1, wherein the magnetic interaction module further comprises at least one sensor configured to generate motion data associated with movement of the second magnetic element.

8. The system of claim 7, wherein the at least one sensor comprises an optical sensor, a Hall-effect sensor, or an inertial sensor.

9. The system of claim 1, wherein the dimensional interaction module comprises a sizing plate having a plurality of apertures or grooves each corresponding to a respective predetermined object diameter.

10. The system of claim 9, wherein the sizing plate further comprises a thickness gauge comprising a wedge, ramp, or stepped surface.

11. The system of claim 1, wherein the dimensional interaction module is physically separate from the mass measurement module and the magnetic interaction module.

12. The system of claim 1, wherein the dimensional interaction module is integrated into a housing of the portable physical testing apparatus.

13. The system of claim 1, wherein the computing device further comprises at least one camera configured to capture image data associated with the object.

14. The system of claim 13, wherein the at least one camera comprises a first camera arranged to capture a first side of the object and a second camera arranged to capture a second side of the object.

15. The system of claim 1, wherein the software application is configured to generate frequency-domain data from the acoustic data.

16. The system of claim 15, wherein the software application is configured to identify a plurality of spectral peaks in the frequency-domain data.

17. The system of claim 1, wherein the reference dataset comprises at least one of dimensional reference data, acoustic reference data, magnetic reference data, and image reference data.

18. The system of claim 1, wherein the reference dataset is stored locally on the computing device.

19. The system of claim 1, wherein the portable physical testing apparatus further comprises a housing configured to position the object at a predetermined location relative to the mass measurement module and the magnetic interaction module.
